(19) United States
(12) Patent Application Publication
(10) Pub. No.: US 2015/0139705 A1
(43) Pub. Date: May 21, 2015

(54) BELT DEVICE, FIXING DEVICE AND IMAGE FORMING APPARATUS

(71) Applicants: Yuusuke FURUICHI, Osaka (JP); Yoshihiro FUKUHATA, Hyogo (JP)

(72) Inventors: Yuusuke FURUICHI, Osaka (JP); Yoshihiro FUKUHATA, Hyogo (JP)

(21) Appl. No.: 14/526,925

(22) Filed: Oct. 29, 2014

(30) Foreign Application Priority Data
Nov. 18, 2013 (JP) 2013-237841

(51) Int. Cl. G03G 15/20

(52) U.S. Cl. CPC G03G 15/2085
USPC 399/329

(57) ABSTRACT

A belt device includes a plurality of support members including an opposed support member and a non-opposed support member; a belt rotatably supported by the plurality of support members; a drive roller disposed opposite any one of the plurality of support members with the belt sandwiched in between, a rotary drive force is transmitted to one end in an axial direction thereof; a drive roller retainer to retain an end in the axial direction of the drive roller and maintain a constant between the drive roller and the opposed support member; an opposed support member retainer to allow the opposed support member to advance toward and retreat from the opposed support member and the drive roller; and a bias applier to bias the opposed support member toward the drive roller.

### CROSS-REFERENCE TO RELATED APPLICATIONS

The present application claims priority pursuant to 35 U.S.C. §119(a) from Japanese patent application number 2013-237841, filed on Nov. 18, 2013, the entire disclosure of which is incorporated by reference herein.

### BACKGROUND

1. Technical Field

Exemplary embodiments of the present invention relate to a belt device to rotate a belt using a drive roller, a fixing device including the belt device, and an image forming apparatus.

2. Background Art

Conventionally, a fixing device including a roller-shaped heating member and a support member such as a pad or a roller, a belt stretched around the heating member and the support member, and a rotatable drive roller or a pressure roller has been known. A driving force of the drive roller is transmitted via a driven gear disposed at one end of the drive roller. The belt rotates accompanied by the drive roller and is heated by the heating member. In addition, the drive roller to support the belt is pressed against a support member with the belt sandwiched in between, so that the drive roller presses against an outer circumferential surface of the belt at a portion of the belt backed up by the support member. With this arrangement, the portion of the belt supported by the support member and the drive roller contact each other with a predetermined pressure, thereby forming a fixing nip. When a recording medium or sheet passes through the fixing nip, an image on the recording sheet is fixed onto the recording sheet with heat and pressure.

As one approach, a wobble prevention roller that prevents the belt from wobbling is known. The wobble prevention roller is disposed upstream of the fixing nip in the belt moving direction and presses against an end portion along the axis of the support member winding around the belt. An outer circumferential surface of the wobble prevention roller has a tapered shape in which a diameter thereof increases outward along the axis of the belt.

### SUMMARY

In one embodiment of the disclosure, there is provided an optimal belt device including: a plurality of support members including an opposed support member and a non-opposed support member; a belt rotatably supported by the plurality of support members; a drive roller disposed opposite any one of the plurality of support members with the belt sandwiched in between, the drive roller to which a rotary drive force is transmitted to one end in an axial direction thereof; a drive roller retainer to retain an end in the axial direction of the drive roller and maintain a constant distance between the drive roller and the opposed support member disposed opposite the drive roller; an opposed support member retainer to allow the opposed support member to advance toward and retreat from the opposed support member and the drive roller; and a bias applier to bias the opposed support member toward the drive roller.

Also disclosed is a fixing device including the belt device as described above. The fixing device is configured to fix an image onto a recording medium when the recording medium carrying the image thereon passes through a nip formed by the belt and the drive roller contacting each other.

Also disclosed is an image forming apparatus that includes the above described fixing device and an image forming unit to form an image on the recording medium.

These and other objects, features, and advantages of the present invention will become apparent upon consideration of the following description of the preferred embodiments of the present invention when taken in conjunction with the accompanying drawings.

### BRIEF DESCRIPTION OF THE DRAWINGS

FIG. 1 illustrates a schematic view of an image forming apparatus according to an embodiment of the present invention;

FIG. 2 is a cross-sectional view of a fixing device schematically illustrating principal parts thereof according to an embodiment of the present invention;

FIG. 3 illustrates a conventional fixing device including a heat roller, a fixing stay, a pressure roller, and retainers disposed at lateral ends thereof;

FIG. 4 illustrates a drive transmission system to drive the pressure roller and the heat roller;

FIG. 5 illustrates a drive force generated at a pressure roller gear in the conventional fixing device;

FIG. 6 illustrated a layout of a gear;

FIG. 7 illustrates a fixing device including a heat roller, a fixing stay, a pressure roller, and retainer mechanisms disposed at lateral ends thereof according to a first embodiment of the present invention;

FIG. 8 is a cross-sectional view of a fixing device schematically illustrating principal parts thereof according to second and third embodiments of the present invention;

FIG. 9 illustrates the fixing device of FIG. 8 including a heat roller, a fixing stay, a pressure roller, and retainers disposed at lateral ends thereof according to a second embodiment of the present invention;

FIG. 10 illustrates the fixing device of FIG. 8 including a heat roller, a fixing stay, a pressure roller, and retainers disposed at lateral ends thereof according to a third embodiment of the present invention;

FIG. 11 is a cross-sectional view of a fixing device schematically illustrating principal parts thereof according to a fourth embodiment of the present invention;

FIG. 12 illustrates a fixing device including a heat roller, a fixing stay, a pressure roller, and retainers disposed at lateral ends thereof according to a further another embodiment of the present invention;

FIG. 13 illustrates how the axial position of the pressure roller is fixed via a common retainer as configured as in FIG. 12;

FIG. 14 illustrates a friction N and a radius R of the pressure roller between the fixing pad and the fixing belt; and

FIG. 15 illustrates a perspective view of the fixing pad in the fixing device according to an embodiment of the present invention.

### DETAILED DESCRIPTION

Hereinafter, exemplary embodiments of the present invention will be described referring to drawings.

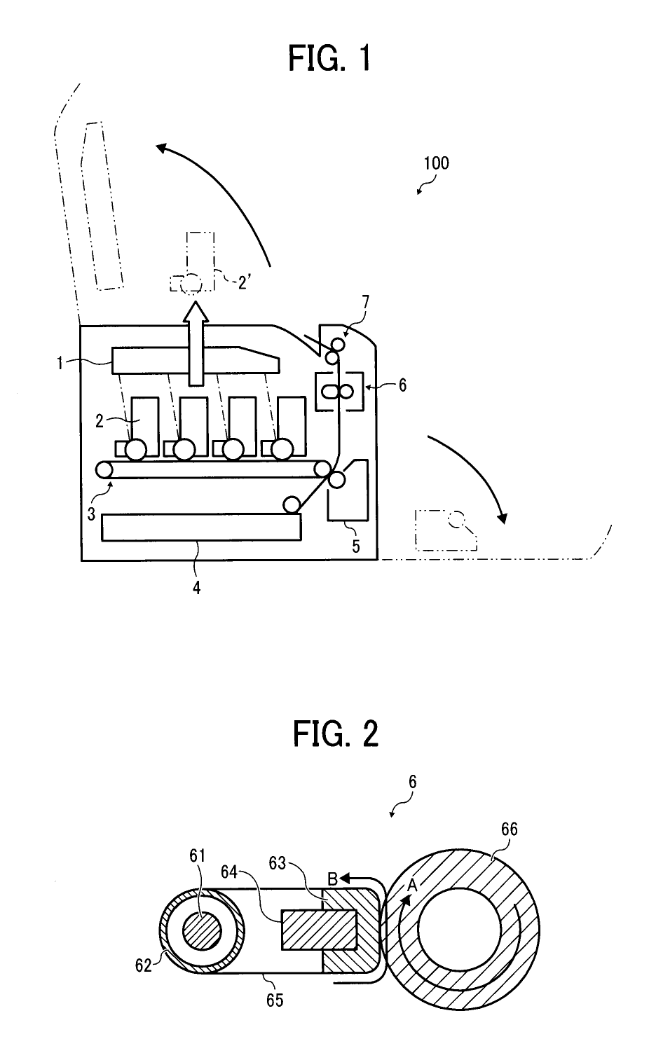

FIG. 1 illustrates a schematic view of an image forming apparatus 100 according to an embodiment of the present invention;

In the present embodiment, a case in which the image forming apparatus is a printer will be described; however, the present embodiment can be applied to copiers, facsimile machines, and other types of image forming apparatuses such as multifunction apparatuses, other than the printer.

As illustrated in FIG. 1, the image forming apparatus 100 according to the present embodiment is a tandem-type, electrophotographic color image forming apparatus to form images in accordance with a common imaging process using an electrophotographic method.

The image forming apparatus 100 includes a writing device 1 as an optical writing or exposure device, and a process cartridge 2 as an image forming section including one of four different colors of toner, that is, black, cyan, magenta, and yellow. The toner for use in the present embodiment includes oil-containing silica as an external additive. Further, the image forming apparatus includes a primary transfer device 3, a sheet feeder 4, a secondary transfer device 5, a fixing device 6, and a sheet discharge roller 7 serving as a recording media discharging device. The primary transfer device 3 superimposes toner images formed in each of the process cartridges 2 on an intermediate transfer belt. The secondary transfer device 5 transfers the toner image on the intermediate transfer belt transferred by the primary transfer device 3, onto a sheet as a recording medium. The sheet feeder 4 used to stack a plurality of sheets thereon also serves to supply each sheet to a transfer position at which the secondary transfer device 5 performs transferring. The fixing device 6 fixes the toner image onto the sheet and the sheet discharge roller 7 discharges the sheet onto which the toner image has been fixed. The primary transfer device 3, the sheet feeder 4, the secondary transfer device 5 and the fixing device 6 each are integrally formed as a unit detachably attachable to the apparatus body, so that they are called a primary transfer unit, a sheet feed unit, a secondary transfer unit, and a fixing unit, respectively.

In general, the fixing device employing a belt may experience wobbling that shifts the belt sideways when the belt is rotating, which may cause damage the belt. As a factor causing wobbling of the belt, there is an inclination of the widthwise pressing force in the fixing nip as described below, called deviation of the fixing load. The torque is transmitted from a drive source via a driven gear disposed at one end to the drive roller or the pressure roller. Depending on an engagement position of a drive gear of the drive source side with the driven gear, there may be a case in which such a force to cause the end where the driven gear of the drive roller is disposed to approach the belt, or inversely, separate from the belt is generated. If such a force is generated at one end of the drive roller, the force of the drive roller that presses the fixing belt becomes greater or smaller than at the other end. This differenced in pressure causes the inclination of the pressing force occurs along the axis of the fixing nip. Due to this inclination of the pressing force along the axis of the fixing nip, wobbling may be generated in the belt that passes through the fixing nip.

FIG. 2 is a cross-sectional view of the fixing device 6 schematically illustrating principal parts thereof according to an embodiment of the present invention.

The fixing device 6 includes a heat roller 62 as a non-opposed support member, a fixing pad 63 as an opposed support member disposed opposite the fixing device 6, a fixing stay 64 as an opposed support member retainer, a fixing belt 65, and a pressure roller 66 as a drive roller. The fixing stay 64 serves to retain the fixing pad 63 in place. The heat roller 62 includes a built-in heater 61 as a heat source to generate heat to heat the fixing nip. The fixing stay 64 allows the fixing pad 63 to advance toward and retreat from the pressure roller 66, and has a predetermined stiffness to prevent deformation due to applied pressure. The pressure roller 66 receives a rotary drive force at one end and contacts against the fixing pad 63 with the fixing belt 65 sandwiched in between. The fixing belt 65 is rotatably supported by a heat roller 62 and a fixing pad 63 so that a fixing nip through which a sheet passes is formed between the fixing belt 65 and the pressure roller 66.

As illustrated in FIG. 2, as the pressure roller 66 is rotated in the direction indicated by arrow A the fixing belt 65 is driven to rotate in the direction indicated by arrow B while rubbing against the fixing pad 63. In addition, the fixing pad 63 may include a sheet-like member with a low coefficient of friction to improve slidability of the fixing belt 65.

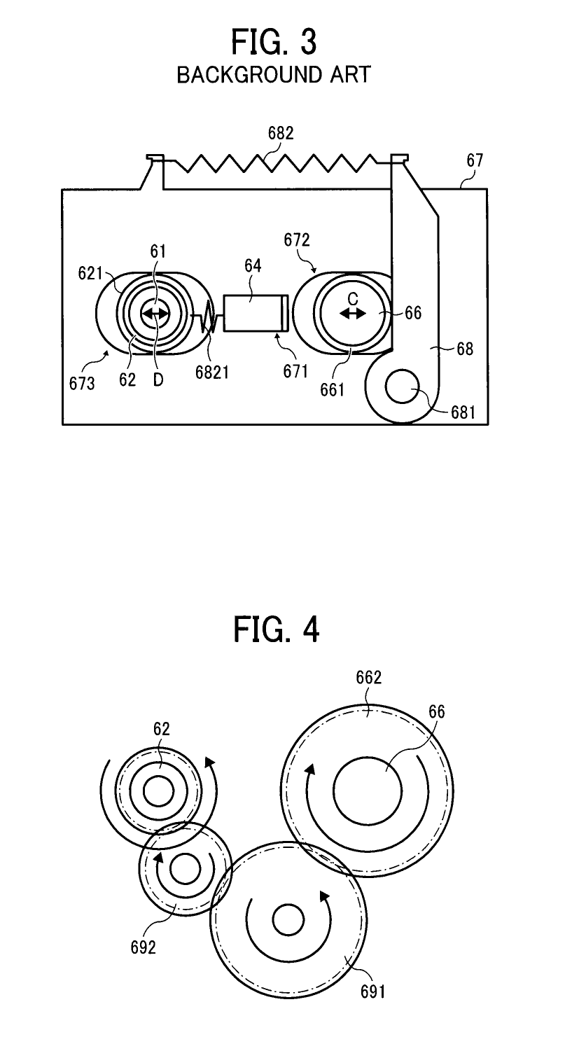

FIG. 3 illustrates a conventional fixing device including a heat roller, a fixing stay, a pressure roller, and retainers disposed at lateral ends thereof.

As illustrated in FIG. 3, the fixing stay 64 is primarily secured to a frame 67 by a stay retainer slit 671 disposed on the frame 67. The pressure roller 66 is retained by a pressure roller retainer slit 672 via a pressure roller bearing 661. The pressure roller bearing 661 is movable in the direction indicated by arrow C inside the pressure roller retainer slit 672. The conventional fixing device further includes a pressure lever 68 rotatable about a supporting point 681, and a pressure spring 682. The pressure lever 68 contacts the pressure roller bearing 661 with pressure via the pressure spring 682 and applies a load for fixation to the fixing pad 63. The pressure roller 66 has a rubber layer. When the pressure roller 66 contacts the fixing pad 63 with pressure, the rubber layer deforms to a certain extent, so as to position the pressure roller 66. On the other hand, the heat roller 62 is retained by a heat roller retainer slit 673 via a heat roller bearing 621. The heat roller bearing 621 is movable in the direction indicated by arrow D inside the heat roller retainer slit 673. Further, a belt tension spring 6821 serving as a tensioner is disposed between the heat roller bearing 621 and the fixing stay 64, and applies a predetermined tension to the belt.

FIG. 4 illustrates a drive transmission system to drive the pressure roller 66 and the heat roller 62. The drive transmission system includes an idler gear 691 as a link gear and a pressure roller gear 662 as a driven gear. The pressure roller gear 662 is driven by a rotary drive force transmitted from the drive gear of the apparatus body, via the idler gear 691. The drive transmission system further includes a heat roller gear 692 as a gear driven by the heat roller 62. The heat roller gear 692 is driven via the idler gear 691 as a link gear.

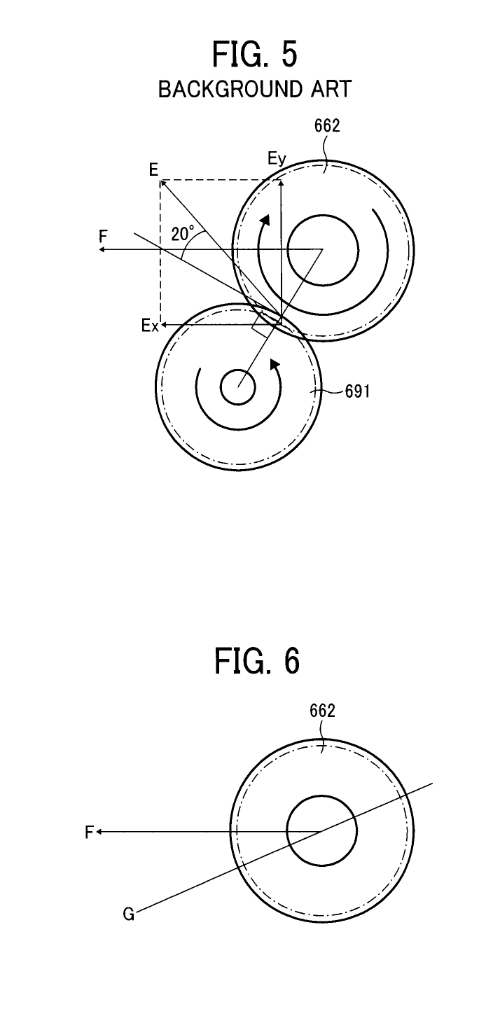

FIG. 5 illustrates a drive force generated at a pressure roller gear 662 in the conventional fixing device.

In FIG. 5, a drive force is applied to the pressure roller gear 662 in the direction of arrow E, which is slanted by 20 degrees, being a press angle of the gear, from a perpendicular line of a line connecting rotary axes of the gears 662 and 691. This drive force can be decomposed into a horizontal component force Ex and a vertical component force Ey. Because the component force Ex is in the same direction of a fixing load applying direction F, the driver side is subjected to the horizontal component force Ex of the drive force of the gear in addition to the fixing load, so that the fixing loads are different between the sides with and without the gear. If there is a load difference, the drive force of the fixing belt 65 differs axially from side to side, resulting in belt wobbling.

For preventing the belt wobbling, the following three methods are conceivable:

(1) Gears are laid out such that the gear drive force direction E becomes vertical (that is, perpendicular to a horizontal direction);

(2) Some part to forcibly prevent wobbling of the fixing belt is added; and

(3) The fixing load of the gear side is reduced, foreseeing the horizontal component force Ex of the drive force.

However, the above method (1) narrows options for the gear layout. Specifically, if the press angle of the gear is set to 20 degrees, the gear should be disposed on a line G as illustrated in FIG. 6. In addition, if the position is shifted due to part or component tolerances, a remarkable component force Ex is generated.

The above method (2) may raise the cost. The above method (3) may cause a remarkable component force Ex to be generated due to initial errors or fluctuations over time of a torque, because the drive force depends on the torque to drive the pressure roller 66.

By contrast, in the present embodiment, the fixing device 6 is configured in the following manner.

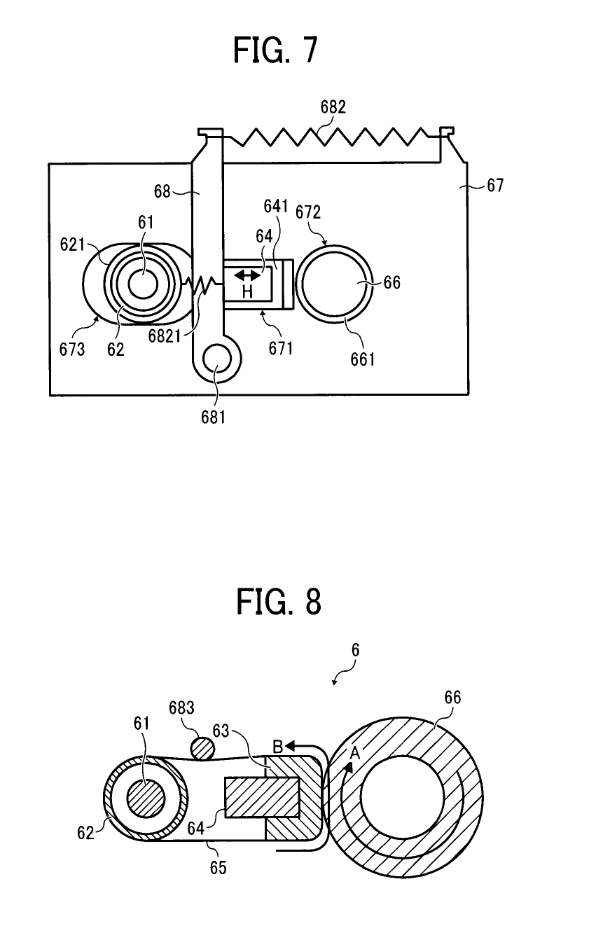

FIG. 7 illustrates the fixing device 6 including the heat roller 62, the fixing stay 64, the pressure roller 66, and retainers disposed at lateral ends of respective members according to the first embodiment of the present invention. The fixing device 6 includes a belt device including: a plurality of support members including a fixing pad 63 serving as an opposed support member and the heat roller 62 as a non-opposed support member; and the fixing belt 65 rotatably supported by the fixing pad 63 and the heat roller 62. The belt device further includes the pressure roller 66 that is disposed opposite and contacted against the fixing pad 63 with the fixing belt 65 sandwiched in between, and receives a rotary drive force at one end.

As illustrated in FIG. 7, the pressure roller retainer slit 672 disposed on a frame 67 engages with the pressure roller bearing 661. The pressure roller bearing 661 is preferably made of a C-shaped slide bearing. In addition, the stay retainer slit 671 disposed on the frame 67 allows the fixing stay 64 to be movable in a direction indicated by arrow H via the stay retainer member 641. The pressure lever 68 rotatable about the supporting point 681 is contacted against the fixing stay 64 by the pressure spring 682 and applies a load for fixation to the fixing stay 64. On the other hand, the heat roller 62 is retained by the heat roller retainer slit 673 via the heat roller bearing 621. The heat roller bearing 621 is preferably made of a C-shaped slide bearing. The heat roller bearing 621 is movable in the arrow D direction inside the heat roller retainer slit 673. The belt tension spring 6821 is disposed between the heat roller bearing 621 and the fixing stay 64, and applies a predetermined tension to the belt.

As illustrated in FIG. 7, the fixing device 6 includes a drive roller retainer to retain an end in the axial direction of the pressure roller 66 so that the position of the rotary axis of the pressure roller 66 does not change relative to the distance between the fixing pad 63 and the pressure roller 66. The drive roller retainer is constructed of the pressure roller retainer slit 672 of the frame 67 and the pressure roller bearing 661. The opposed support member retainer serving to retain the fixing pad 63 so as to be movable relative to the distance between the fixing pad 63 and the pressure roller 66 is constructed of the fixing stay 64 and the stay retainer slit 671 of the frame 67. In addition, a bias applier to bias the fixing pad 63 toward the pressure roller 66 is constructed of the pressure lever 68 and the pressure spring 682.

If constructed as illustrated in FIG. 7, the axial position of the pressure roller 66 is fixed. Accordingly, if the drive force of the drive gear is applied from the apparatus body to the pressure roller gear 662, because the pressure roller bearing 661 receives the drive force, no load is applied to the fixing pad 63. The fixing load is formed only by a load with which the pressure lever 68 biases the fixing stay 64. Thus, because there is no deviation in the fixing load along the axis of the belt due to the drive force of the gear disposed at one end of the pressure roller 66, the fixing belt 65 of the fixing device 6 does not tend to wobble.

FIG. 8 is a cross-sectional view of a fixing device 6 schematically illustrating principal parts thereof according to second and third embodiments of the present invention. In FIG. 8, parts or components similar to parts or components illustrated in FIG. 2 are given the same reference numerals and redundant description thereof omitted. The fixing device 6 according to the second or third embodiment differs from the embodiment illustrated in FIG. 2 in that a tension roller 683 to apply pressure to the fixing belt 65 is disposed on the fixing belt 65.

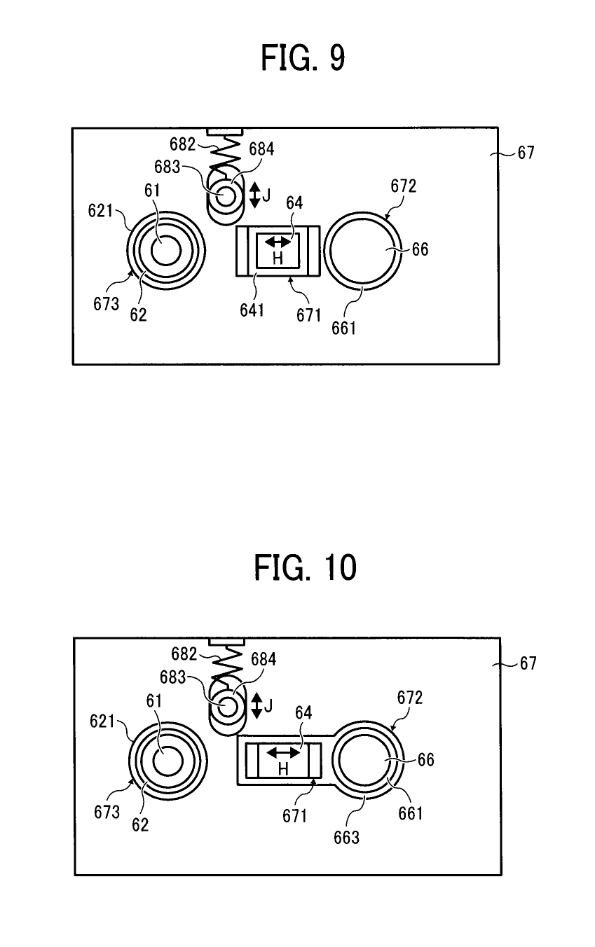

FIG. 9 illustrates the fixing device 6 of FIG. 8 according to the second embodiment including the heat roller 62, the fixing stay 64, the pressure roller 66, and retainers disposed at lateral ends of respective members. In FIG. 9, parts or components similar to the parts or components illustrated in FIG. 7 are given the same reference numerals and redundant description thereof omitted. In addition, the pressure lever 68 is not illustrated in FIG. 9; however, the fixing stay 64 is biased toward the pressure roller 66 via the pressure lever 68 similarly to FIG. 7.

The fixing device 6 illustrated in FIG. 9 differs from the fixing device 6 of FIG. 7 in that the heat roller retainer slit 673 and the heat roller bearing 621 are engaged with each other and the tension roller 683 as a tensioner is movably retained in the direction indicated by arrow J via a tension roller retainer 684. The heat roller retainer slit 673 and the heat roller bearing 621 are engaged, thereby securely positioning the heat roller bearing 621. With this structure, parallelism among the pressure roller 66, the fixing stay 64, and the heat roller 62 is improved, thereby preventing wobbling of the belt due to degraded parallelism. As illustrated in FIG. 9, the non-opposed support member retainer to retain an end in the axial direction of the heat roller 62 so that the position of the rotary axis of the heat roller 62 does not change, is constructed of the heat roller retainer slit 673 of the frame 67 and the heat roller bearing 621.

FIG. 10 illustrates the fixing device 6 of FIG. 8 according to the third embodiment including the heat roller 62, the fixing stay 64, the pressure roller 66, and retainers disposed at lateral ends of respective members. In FIG. 10, parts or components similar to parts or components illustrated in FIGS. 7 and 9 are given the same reference numerals and redundant description thereof is omitted.

The fixing device 6 illustrated in FIG. 10 differs from the fixing device 6 of FIG. 7 in that the tension roller 683 is movably retained in the arrow J direction via the tension roller retainer 684, and that the pressure roller 66 and the fixing stay 64 are retained with a common retainer 663. In the present embodiment, because the common retainer 663 determines positions of the pressure roller 66 and the fixing stay 64, positional accuracy of the pressure roller 66 and the fixing stay 64 is improved over an arrangement providing respective retainers, thereby preventing the belt from approaching either side of the fixing belt 65. The shape of the common retainer 663 to retain respective lateral ends of the pressure roller 66 and the fixing stay 64 is the same. With this structure, parallelism between the pressure roller 66 and the fixing stay 64 at both lateral ends due to an improper accuracy of the common retainer 663 is prevented from degrading.

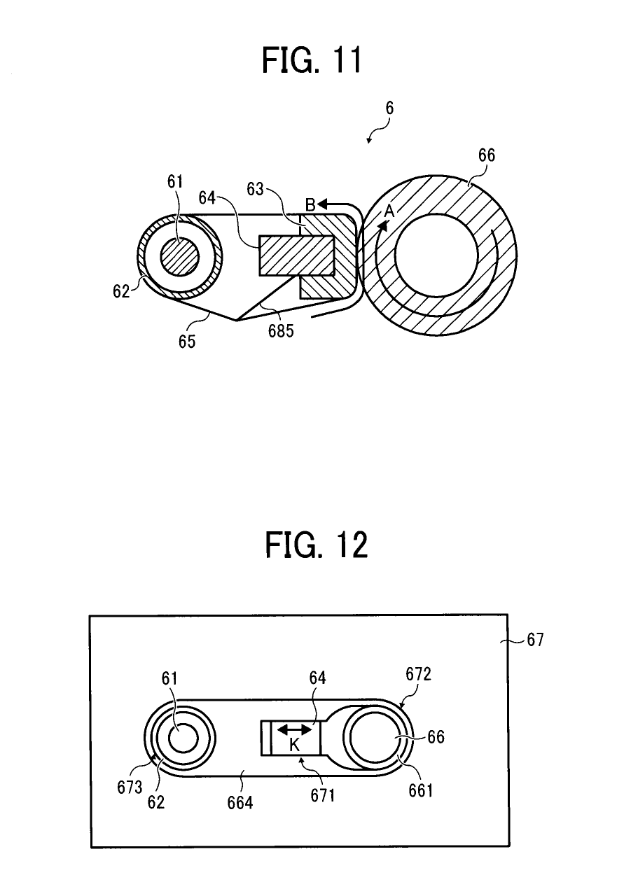

FIG. 11 is a cross-sectional view of a fixing device 6 schematically illustrating principal parts thereof according to a fourth embodiment of the present invention. In FIG. 11, parts or components similar to parts or components illustrated in FIGS. 2 and 8 are given the same reference numerals and redundant description thereof omitted. The fixing device 6 according to the fourth embodiment differs from the embodiment illustrated in FIG. 8 in that a blade spring 685 applies pressure to the fixing belt 65. Thermal calorie of the blade spring is smaller than that of the tension roller, so that energy saving can be achieved.

In addition, it is preferred that the blade spring 685 be contacted a surface of the fixing belt 65 not used for the image fixation. Contact pressure of the blade spring 685 is preferably set greater at the lateral ends than the center of the fixing belt 65 axially.

FIG. 12 illustrates the fixing device 6 including the heat roller 62, the fixing stay 64, the pressure roller 66, and retainers disposed at lateral ends of respective members according to further another embodiment in the present invention. In FIG. 12, parts or components similar to parts or components illustrated in FIGS. 7 and 9 are given the same reference numerals and redundant description thereof omitted.

In an example illustrated in FIG. 12, the pressure roller 66, the fixing stay 64, and the heat roller 62 are all retained by a common retainer 664. With this structure, parallelism among the pressure roller 66, the fixing stay 64, and the heat roller 62 is improved, thereby more securely preventing wobbling of the belt due to degraded parallelism. It is noted that the pressure roller bearing 661 is not engaged perfectly, but is movable in an arrow K direction.

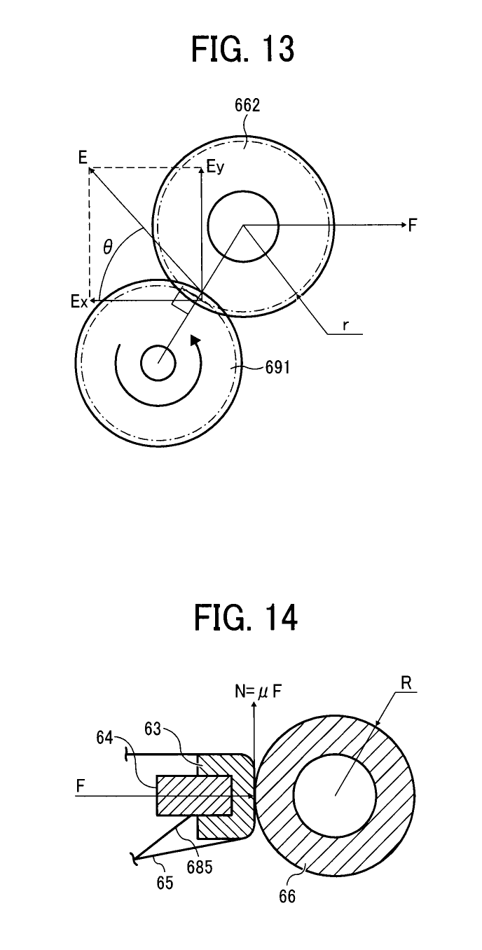

FIG. 13 illustrates how the axial position of the pressure roller 66 is fixed via the common retainer 664 as configured as in FIG. 12.

As illustrated in FIG. 13, a fixing load and a gear drive force are applied to the pressure roller 66 in an arrow F direction and arrow E direction, respectively. If the fixing load F is greater as a result of comparing the horizontal component force Ex of the gear drive force E and the fixing load F, the pressure roller 66 is pressed against the internal surface of the pressure roller retainer slit 672 that positions at a rightmost of the common retainer 664 (see FIG. 12), and is positioned unambiguously. On the other hand, as to a horizontal component force Ex of the gear drive force, the following relation (1) stands:

Ex=E×cos θ=(T/r)×cos θ (1),

where T is a drive torque of the pressure roller 66, r is a pitch circle radius of the pressure roller gear 662, and θ is an angle formed between a horizontal direction and a direction of the gear drive force.

Further, as illustrated in FIG. 14, coefficient of friction between the fixing pad 63 and the fixing belt 65 is set to μ as illustrated in FIG. 14, and the radius of the pressure roller 66 is set to R, the drive torque T of the pressure roller 66 can be represented by the following formula (2):

T=N×R=μ×F×R (2)

By substituting above formula (2) into the above formula (1), a following equation (3) is obtained.

Ex=μ×F×(R/r)×cos θ (3)

The following formula (4) satisfies a condition to satisfy F>Ex and the following formula (5) can be obtained by multiplying r/F to both sides.

F>μ×F×(R/r)×cos θ (4);

r>μ×R×cos θ (5)

Herein, coefficient of friction of general grease lubrication is approximately 0.1, and cos θ is less than 1, so that the pitch circle radius r of the pressure roller gear 662 is so set as to satisfy the following formula (6), the axial center position of the pressure roller 66 is fixed. As a result, wobbling of the belt due to degraded parallelism is further minimal and the fixing device with less belt wobbling can be obtained.

r>0.1×R (6)

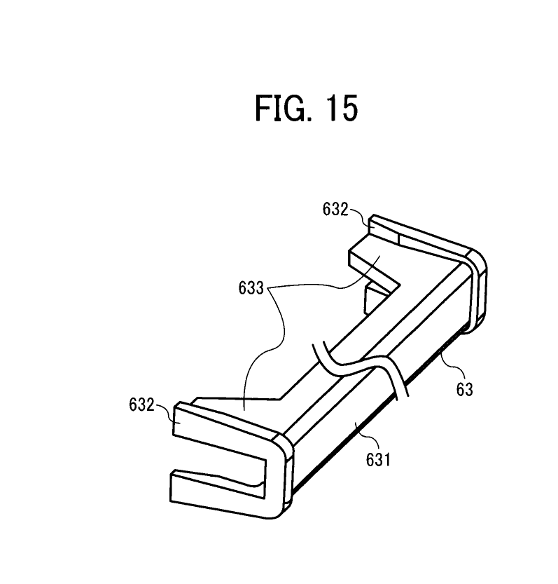

FIG. 15 illustrates a perspective view of the fixing pad 63.

As illustrated in FIG. 15, the fixing pad 63 includes a nip forming portion 631, wobbling regulation portions 632, and buckling prevention portions 633. The nip forming portion 631 presses against the pressure roller 66 with the fixing belt 65 sandwiched in between, thereby forming a fixing nip. The wobbling regulation portions 632 regulates wobbling of the fixing belt 65. The buckling prevention portions 633 contacts an inner side of the fixing belt 65 when the wobbled fixing belt 65 contacts the wobbling regulation portions 632, so as to prevent buckling of the fixing belt 65.

The fixing pad 63 is made of polyphenylene sulfide (PPS) resin without glass. Alternatively, the fixing pad 63 may be made of polyamideimide (PAI) resin instead of PPS resin. On the other hand, materials of the fixing belt 65 may include polyimide (PI) resin for a base; silicone rubber for an elastic member; and copolymers of tetrafluoroethylene-perfluoroalkyl vinylether (PFA) resin for a surface layer.

Table 1 shows actual printing test results executed using respective image forming apparatuses, including the conventional fixing device, and fixing devices according to the first to fourth embodiments.

The actual tests were executed by counting the number of prints when the fixing belt 65 is broken due to wobbling of the belt. Using a chart with an image area ratio of 5%, printing of three sheets with an image on one side was repeated. As shown in Table 1, the numbers of prints achieved until the belt was broken was greater in the first to fourth embodiments than in the conventional example.

| | Occurrence of damage due |
|---|---|
| Structure | to belt wobbling |
| Conventional example | Damaged at 50K sheets |
| First embodiment | Damaged at 105K sheets |
| Second embodiment | Damaged at 115K sheets |
| Third embodiment | Damaged at 125K sheets |
| Fourth embodiment | Damaged at 180K sheets |

In addition, in each of the embodiments, the heater 61 as a heat source is provided to the heat roller 62; however, instead of or in addition to the built-in heater 61 disposed inside the heat roller 62, the heater can be disposed at the pressure roller 66 or the fixing stay 64. As long as heat to warm up the fixing nip is generated, any other type of heater can be used.

In each of the embodiments, an example in which the fixing pad serves as an opposed support member and is disposed opposite the pressure roller or the drive roller has been described; however, the present invention can be applied to such a structure in which the opposed support member is a roller other than the fixing pad.

In each of the embodiments, a fixing device using the fixing belt 65 has been described; however, the present invention may be applied to any type of belt device, without limiting to the fixing device, as far as the belt device is configured such that a drive roller contacts an outer circumferential surface of a part of the belt supported by the support member of the belt.

The aforementioned embodiments are examples and specific effects can be obtained for each of the following aspects of (A) to (S):

(Aspect A) A belt device includes a belt such as a fixing belt 65 rotatably supported by a plurality of support members such as a heat roller 62 and a fixing pad 63; a drive roller such as a pressure roller 66 disposed opposite any one of the plurality of support members such as a fixing pad 63 with the belt sandwiched in between, the drive roller by which a rotary drive force is transmitted to one end in an axial direction thereof; among the plurality of support members, a drive roller retainer including a pressure roller retainer slit 672 of a frame 67 and a pressure roller bearing 661 to retain an end in the axial direction of the drive roller lest a position of a rotary axis of the drive roller should change relative to a distance between the drive roller and the opposed support member such as the fixing pad 63 opposite the drive roller; an opposed support member retainer such as a fixing stay 64 and a stay retainer slit 671 of the frame 67 to retain the opposed support member so as to be movable relative to a distance between the opposed support member and the drive roller; and a bias applier such as a pressure lever 68 and a pressure spring 682 to apply biasing force to the opposed support member toward the drive roller.

With the structure in the above embodiment, the fixing device 6 includes a drive roller retainer to retain an end in the axial direction of the drive roller such as the pressure roller 66 so that the position of the rotary axis of the pressure roller 66 does not change relative to the distance between the opposed support member (such as the fixing pad 63) and the pressure roller 66. With the structure as described above, when the rotary drive force is transmitted to an end of the drive roller, the rotary axis of the drive roller does not fluctuate toward the opposed support member. Accordingly, the pressing force generated at a nip portion by the contact between the drive roller and the belt with pressure is not inclined along the axis of the belt, so that wobbling of the belt due to inclination of the pressing force can be securely prevented. In addition, the opposed support member which is not affected by the rotary drive force transmission is biased toward the drive roller, so that a predetermined pressing force may be generated at a nip through which the belt supported by the opposed support member and the drive roller contact each other with pressure. Thus, a predetermined pressing force is generated at a nip through which a part of the outer circumferential surface of the belt supported by the support member of the belt and the drive roller contact, and wobbling of the belt caused by that the rotary drive force is transmitted to one end of the drive roller can be securely prevented.

(Aspect B) In the above aspect A, a non-opposed support member such as the heat roller 62 among the plurality of support members which is not opposite the drive roller is a rotatable, roller-shaped member and includes a non-opposed support member retainer to retain an end in the axial direction of the non-opposed support member so that the position of the rotary axis of the non-opposed support member does not change, is constructed of the heat roller retainer slit 673 of the frame 67 and the heat roller bearing 621. With this structure, as described in the above embodiments, parallelism among the non-opposed support member and the opposed support member is improved, thereby preventing wobbling of the belt due to degraded parallelism.

(Aspect C) In the above aspect B, the drive roller retainer, the opposed support member retainer, and the non-opposed support member retainer are configured such that the drive roller, the non-opposed support member, and the opposed support member are all retained by a common retainer 664 at each lateral end in the longitudinal direction of the drive roller. With this structure, as described in the above embodiments, compared to a case in which each member is retained by a separate member, parallelism among the drive roller, the non-opposed support member, and the opposed support member is improved, thereby preventing wobbling of the belt due to degraded parallelism.

(Aspect D) In the above aspect C, a set of common retainer 664 to integrally retain the drive roller, the non-opposed support member, and the opposed support member at each lateral end in the longitudinal direction of the drive roller has a shape similar to each other. With this structure, as described in the above embodiments, degraded parallelism among the drive roller, the non-opposed support member, and the opposed support member due to deviations in accuracy of retainers is improved, thereby more securely preventing wobbling of the belt due to degraded parallelism.

(Aspect E) In the above aspects A and B, the drive roller retainer and the opposed support member retainer are configured such that the drive roller and the opposed support member are integrally retained by the common retainer 663 at each lateral end in the longitudinal direction of the drive roller. With this structure, as described in the above embodiments, compared to a case in which each member is retained by a separate member, parallelism among the drive roller and the opposed support member is improved, thereby preventing wobbling of the belt due to degraded parallelism.

(Aspect F) In the above aspect E, the set of common retainer 663 to integrally retain the drive roller and the opposed support member at each lateral end in the longitudinal direction of the drive roller has a shape similar to each other. With this structure, degraded parallelism among the drive roller and the opposed support member due to deviations in accuracy of the retainers is improved, thereby more securely preventing wobbling of the belt due to degraded parallelism.

(Aspect G) In any one of the above aspects A to F, a tension roller 683 to contact the belt with a predetermined pressing force to apply a tensile force to the belt is disposed. With this structure, because a tensile force is applied to the belt, the belt is driven more stably, thereby more securely preventing the belt from wobbling.

(Aspect H) In the above aspect G, the tensile force applying member is a blade spring 685. With this structure, use of the blade spring with a lower thermal capacity improves an energy saving effect.

(Aspect I) In the above aspect H, a contact pressure of the blade spring is higher at lateral ends than a center along the axis of the belt. With this structure, the wobbling of the belt can be more securely prevented.

(Aspect J) In any of the aspects A to I, the drive roller retainer retains an end in the axial direction of the drive roller with a C-shaped slide bearing. With this structure, because is used the C-shaped slide bearing of which dimensions are smaller than those of an O-shaped slide bearing, material costs can be reduced, thereby achieving cost reduction.

(Aspect K) In any of the above aspect A to J, if a pitch circle radius of a gear disposed at one end in the drive roller axial direction is set to r and a radius of the drive roller contacting the belt is set to R, r>0.1×R is satisfied. With this structure, even though the bearing of the drive roller is not O-shaped, the end in the drive roller axial direction can be retained so that the rotary axis of the drive roller does not change.

(Aspect L) In any of the above aspects A to K, the opposed support member includes regulation members such as wobbling regulation portions 632 that regulate both ends along the axis of the belt so as to prevent the belt from wobbling. With this structure, because the lateral ends along the axis of the belt are regulated near the nip through which approaching of the belt occurs, approaching of the belt along the axis of the belt can be effectively prevented.

(Aspect M) In any of the above aspects A to L, the opposed support member includes buckling prevention portions to prevent the belt from buckling toward an inner side. With this structure, damage of the end portions of the belt due to buckling can be prevented when the belt approaches along the axis of the belt.

(Aspect N) In any of the above aspects A to M, the base of the belt is made of resin, the material of the opposed support member is polyphenylene sulfide (PPS) resin or polyamideimide (PAI) resin without glass. With this aspect, by making the base of the belt with the resin such as polyimide (PI), reduction of cost is achieved than the use of the belt made of any metal. In addition, by making the material of the opposed support member with the PPS resin or PAI resin without glass, even when the opposed support member rubs against the belt, the belt is not damaged, thereby lengthening the lifetime of the belt.

(Aspect O) The fixing device 6 including a belt device of any of the above aspects A to N to fix an image onto recording media by passing the recording media on which the image has been formed through a nip at which the belt and the drive roller contact with pressure. Thus, a predetermined pressing force is generated at a nip through which a part of the outer circumferential surface of the belt supported by the support member of the belt and the drive roller contact. Further, wobbling of the belt caused by that the rotary drive force is transmitted to one end of the drive roller can be securely prevented.

(Aspect P) In the above aspect O, a blade spring 685 to contact the belt with a predetermined pressing force to apply a tensile force to the belt is disposed, and the blade spring 685 is caused to contact the non-fixation portion of the belt not used for fixation of the image. With this structure, occurrence of the abnormal image due to damage of the belt generated when the blade spring contacts the belt surface for fixation, can be prevented.

(Aspect Q) An image forming apparatus includes an image forming unit such as a process cartridge 2 to form an image on the recording media such as a sheet of paper, and a fixing unit to fix the image on the recording media formed in the image forming unit. The fixing device 6 in the above aspect O or P is included in the image forming apparatus. With this structure, a predetermined pressing force is generated at a nip through which a part of the outer circumferential surface of the belt supported by the support member of the belt and the drive roller contact, and wobbling of the belt caused by that the rotary drive force is transmitted to one end of the drive roller can be securely prevented.

(Aspect R) In the above aspect Q, the fixing device 6 is detachably attachable to the body of the image forming apparatus. With this structure, the fixing device is replaceable with ease.

(Aspect S) In the above aspect Q or R, the image forming unit forms an image on the recording media using toner containing oil-containing silica as an additive. With this structure, fixation performance of the fixing device may be improved.

Additional modifications and variations of the present invention are possible in light of the above teachings. It is therefore to be understood that, within the scope of the appended claims, the invention may be practiced other than as specifically described herein.

What is claimed is:

1. A belt device comprising:
a plurality of support members including an opposed support member and a non-opposed support member;
a belt rotatably supported by the plurality of support members;
a drive roller to which a rotary drive force is transmitted to one end in an axial direction thereof, disposed opposite any one of the plurality of support members with the belt sandwiched in between;
a drive roller retainer to retain an end in the axial direction of the drive roller and maintain a constant distance between the drive roller and the opposed support member disposed opposite the drive roller;
an opposed support member retainer to allow the opposed support member to advance toward and retreat from the opposed support member and the drive roller; and
a bias applier to bias the opposed support member toward the drive roller.

2. The belt device as claimed in claim 1, wherein the non-opposed support member is a rotatable, roller-shaped member and includes a non-opposed support member retainer to retain an end in an axial direction of the non-opposed support member so that position of a rotary axis of the non-opposed support member does not change.

3. The belt device as claimed in claim 2, further comprising a set of common retainers,
wherein the drive roller retainer, the opposed support member retainer, and the non-opposed support member retainer are configured such that the drive roller, the non-opposed support member, and the opposed support member are all retained by the set of common retainers.

4. The belt device as claimed in claim 3, wherein the set of common retainers retains the drive roller, the non-opposed support member, and the opposed support member at each lateral end in a longitudinal direction of the drive roller; and each common retainer of the set of common retainers has the same shape.

5. The belt device as claimed in claim 1, further comprising a set of common retainers,
wherein the drive roller retainer and the opposed support member retainer are configured such that the drive roller and the opposed support member are integrally retained by the set of common retainers at each lateral end in a longitudinal direction of the drive roller.

6. The belt device as claimed in claim 5, wherein the set of common retainers integrally retains the drive roller and the opposite support member at each lateral end in a longitudinal direction of the drive roller; and each of the set of common retainers has the same shape.

7. The belt device as claimed in claim 1, further comprising a tensioner to contact the belt with a predetermined pressing force to apply a tensile force to the belt.

8. The belt device as claimed in claim 7, wherein the tensioner is a blade spring.

9. The belt device as claimed in claim 7, wherein a contact pressure of the blade spring is higher at lateral ends of the belt than at a center of the belt.

10. The belt device as claimed in claim 1, further comprising a C-shaped slide bearing,
wherein the drive roller retainer retains an end in the axial direction of the drive roller with the C-shaped slide bearing.

11. The belt device as claimed in claim 1, further comprising a gear disposed at one end in the axial direction of the drive roller,
wherein r>0.1×R,
where a pitch circle radius of the gear is r and a radius of the drive roller contacting the belt is R.

12. The belt device as claimed in claim 1, wherein the opposed support member includes wobbling regulation portions to regulate both ends in an axial direction of the belt to prevent the belt from wobbling.

13. The belt device as claimed in claim 1, wherein the opposed support member includes buckling prevention portions to prevent the belt from buckling inward.

14. The belt device as claimed in claim 1, wherein the belt has a resin base and the opposed support member is made of polyphenylene sulfide (PPS) resin or polyamideimide (PAI) resin without glass.

15. A fixing device comprising the belt device as claimed in claim 1,
the fixing device configured to fix an image onto a recording medium when the recording medium carrying the image thereon passes through a nip formed by the belt and the drive roller contacting each other.

16. The fixing device as claimed in claim 15, further comprising a blade spring to contact the belt with a predetermined pressing force to apply a tensile force to the belt,
the blade spring contacting the non-fixation portion of the belt not used for fixation of the image.

17. An image forming apparatus comprising:
the fixing device as claimed in claim 15; and
an image forming unit to form an image on the recording medium.

18. The image forming apparatus as claimed in claim 17, wherein the fixing device is detachably attachable to a body of the image forming apparatus.

19. The image forming apparatus as claimed in claim 17, wherein the image forming unit forms the image on the recording medium using toner containing oil-containing silica as an external additive.
